(19) United States
(12) Patent Application Publication
(10) Pub. No.: US 2014/0172532 A1
(43) Pub. Date: Jun. 19, 2014

(54) OPTIMAL UTILIZATION OF COUPONS

(71) Applicant: KT CORPORATION, Gyeonggi-do (KR)

(72) Inventors: Ra-Woon CHOI, Seoul (KR); Dong-Wan KIM, Seoul (KR); Min-Gu LEE, Gyeonggi-do (KR)

(73) Assignee: KT CORPORATION, Gyeonggi-do (KR)

(21) Appl. No.: 14/105,512

(22) Filed: Dec. 13, 2013

(30) Foreign Application Priority Data
Dec. 13, 2012 (KR) 10-2012-0145766

(51) Int. Cl. G06Q 30/02; G06K 19/06

(52) U.S. Cl. CPC G06Q 30/0225; G06K 19/06037
USPC 705/14.26; 235/494

(57) ABSTRACT

The disclosure is related to optimally utilizing coupons stored in user equipment. Information on coupons stored in the user equipment may be collected by scanning memory sectors of the user equipment. A representative coupon code that represents the coupons stored in the user equipment may be generated to include the obtained coupon information with device identification (ID) information, authentication information, and service server information. Such a generated representative coupon code may be outputted upon a predetermined event.

### CROSS REFERENCE TO PRIOR APPLICATIONS

The present application claims priority under 35 U.S.C. §119 to Korean Patent Application No. 10-2012-0145766 (filed on Dec. 13, 2012), which is hereby incorporated by reference in its entirety.

The subject matter of this application is related to U.S. patent application Ser. No. 14/050,677 filed Oct. 10, 2013 as Attorney Docket No.: (801.0101), the teaches of which is incorporated herein in their entirety by reference.

### BACKGROUND

Due to advanced technologies of mobile devices, consumers frequently download digital coupons from an associated server using mobile devices and present the digital coupons to a merchant for obtaining benefits of applicable coupons when the consumers make a payment for a desired purchase. The digital coupon may be a ticket or document that can be exchanged for a financial discount or rebate when purchasing a product. Due to various convenient features thereof, digital coupons have been popular among consumers.

### SUMMARY

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present embodiment, user equipment provides a service for helping a consumer to optimally utilize coupons stored in the user equipment in connection with an associated service server.

In accordance with at least one embodiment, a method of user equipment may be provided for optimally utilizing coupons stored in the user equipment. The method may include collecting information on coupons stored in the user equipment by scanning memory sectors of the user equipment, generating a representative coupon code that represents the coupons stored in the user equipment by including the obtained coupon information with device identification (ID) information, authentication information, and service server information, and outputting the generated representative coupon code upon a predetermined event.

The obtaining information may include downloading coupons from associated servers through different applications installed and executed in the user equipment and storing the downloaded coupons in memory sectors assigned to corresponding applications. The generating a representative coupon code may include generating at least one of a bar code and a quick response (QR) code as the representative coupon code. The coupon information may include information on at least one of a name of each coupon, an applicable merchant of each coupon, a coupon benefit of each coupon, a valid period of each coupon, an N-dimensional code image of each coupon, and a coupon image of each coupon. The device ID information may include information on at least one of a telephone number or an international mobile subscriber identity (IMSI) of the user equipment. The service server information may include at least one of a uniform resource locator (URL) address and an internet protocol (IP) address of an associated service server. The authentication information may include at least one of a personal identification number (PIN), device identification (ID) information, predetermined personal information, and a hashing result of at least one of the PIN, the device ID information, and the predetermined personal information.

The outputting the generated representative coupon code may include transmitting the generated representative coupon code to a merchant terminal through a communication link established between the user equipment and the merchant terminal. The outputting the generated representative coupon code may include displaying the generated representative coupon code on a display device of the user equipment.

The predetermined event may include receiving a user input for displaying the representative coupon code, receiving a user input for initiating an associated service application, receiving a user input for initiating a payment process, and receiving a predetermined signal transmitted from a merchant terminal or an associated service server.

The method may include transmitting a registration request with the generated representative coupon code, the authentication information, and the device ID information to a service server.

The method may further include receiving a coupon deletion request from the service server and deleting coupon information associated with the coupon deletion request.

In accordance with another embodiment, a method of a merchant terminal may be provided for optimally utilizing coupons stored in user equipment. The method may include obtaining information on a representative coupon code from the user equipment, obtaining information on applicable coupons to at least one of a related merchant and a desired purchase based on the obtained representative coupon code from an associated service server, and performing a payment procedure with applying at least one of the applicable coupons based on the obtained information.

The obtaining information on a representative coupon code may include receiving information on the representative coupon code from the user equipment through a communication link established between the user equipment and the merchant terminal or scanning the representative coupon code displayed on a display device of the user equipment.

The obtaining information on applicable coupons may include extracting authentication information, service server information, and device ID information from the obtained representative coupon code by decoding the obtained representative coupon code, transmitting a coupon request with the extracted authentication information, the extracted device ID information, and merchant identification (ID) information to the associated service server based on the extracted service server information, and receiving the information on applicable coupons to at least one of a related merchant and a desired purchase from the associated service server. The method may further include transmitting a used coupon confirmation request to the associated service server after the performing a payment procedure.

In accordance with still another embodiment, a method of a service server may be provided for optimally utilizing coupons stored in user equipment. The method may include receiving a coupon request from a merchant terminal, obtaining information on coupons applicable to a related merchant or a desired purchase based on the received coupon request, and providing the obtained information to at least one of the merchant terminal and the user equipment.

The obtaining information may include extracting device identification (ID) information and merchant identification (ID) information from the received coupon request and obtaining the information on applicable coupons based on at least one of the device ID information and the merchant ID information.

The method may include extracting authentication information from the received coupon request and performing an authentication procedure of the coupon request based on the extracted authentication information. The method may further include receiving a registration request with a representative coupon code, coupon information, authentication information, and device identification (ID) information from the user equipment and storing the representative coupon code, the coupon information, and the authentication information in connection with the device ID information of the user equipment. The method may further include receiving a used coupon confirmation request from the merchant terminal and deleting information on coupons indicated as a used coupon based on the received used coupon confirmation request. The method may further include transmitting a coupon deletion request to user equipment for deleting the detected coupons.

### BRIEF DESCRIPTION OF THE DRAWINGS

The above and/or other aspects of the present invention will become apparent and more readily appreciated from the following description of embodiments, taken in conjunction with the accompanying drawings, of which:

FIG. 1 illustrates a system for providing a service for helping a consumer to optimally utilize coupons in accordance with at least one embodiment of the present invention;

FIG. 2 illustrates user equipment for providing a service helping a consumer to optimally utilize stored coupons in accordance with at least one embodiment of the present invention;

FIG. 3 illustrates a method for generating a representative coupon code at user equipment and registering the generated representative coupon code at a service server in accordance with at least one embodiment;

FIG. 4 illustrates a representative coupon code in accordance with at least on embodiment; and

FIG. 5 illustrates a method for providing a service for helping a consumer to optimally utilize coupons stored in user equipment in accordance with at least one embodiment.

### DESCRIPTION OF EMBODIMENTS

Reference will now be made in detail to embodiments of the present invention, examples of which are illustrated in the accompanying drawings, wherein like reference numerals refer to like elements throughout. The embodiments are described below, in order to explain the present invention by referring to the figures.

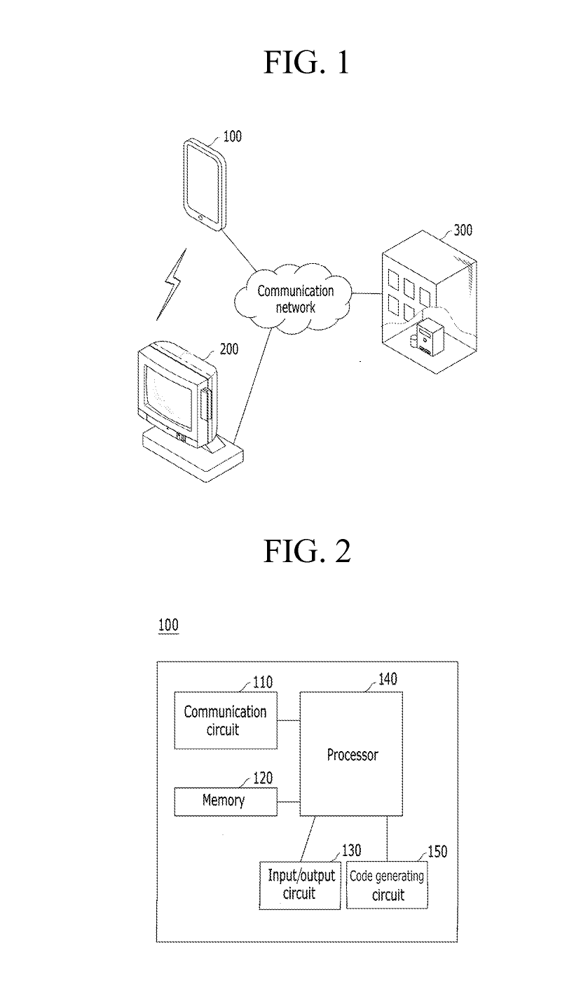

In accordance with at least one embodiment, a consumer is provided with a service for optimally utilizing coupons through user equipment. In order to provide such a service, user equipment generates and outputs a representative coupon code for a plurality of coupons stored in user equipment. Such a service may be provided through a service application installed and executed in user equipment in association with a related service server. Hereinafter, a system for providing such a service will be described with a reference to FIG. 1.

FIG. 1 illustrates a system for providing a service for helping a consumer to optimally utilize coupons stored in user equipment in accordance with at least one embodiment of the present invention.

Referring to FIG. 1, a system includes user equipment 100, merchant terminal 200, and service server 300. The system provides a service for helping a consumer to make the most of coupons digitally issued through user equipment 100 and/or stored in user equipment 100 in connection with service server 300 in accordance with at least one embodiment.

User equipment 100 is an electronic device that provides a service for helping a consumer to optimally utilize a plurality of coupons digitally stored therein by generating and outputting a representative coupon code for the plurality of stored coupons in accordance with at least one embodiment. For example, i) user equipment 100 may be provided with information on a plurality of coupons from related servers and store the provided coupon information. ii) User equipment 100 may generate a representative coupon code based on the stored coupon information (e.g., information on the plurality of issued coupons). iii) User equipment 100 may register the generated representative coupon code at service server 300 with the coupon information. iv) User equipment 100 outputs such a representative coupon code upon a predetermined event. Based on the representative coupon code, merchant terminal 200 might be enabled to automatically select coupons applicable to a desired purchase in connection with service server 300.

The coupon denotes a ticket or document that can be exchanged for a financial discount or rebate if it is presented when a payment is made for a purchase with a payment instrument. Such coupon may be digitally installed or stored in user equipment 100. That is, the plurality of coupons may be digitally issued or downloaded from associated servers through various types of applications installed and executed in user equipment 100. User equipment 100 may store information on such issued coupons in scattered memory sectors of a memory and assigned to corresponding applications.

The representative coupon code may be a code containing information for representing all of coupons digitally stored in user equipment 100. For example, the representative coupon code may be generated to include at least one of: a) information on coupons digitally stored in user equipment 100, b) information on benefits of each coupon, c) information on user equipment 100, d) information for authentication, and e) information on an associated service server. That is, the representative coupon code includes at least one of a) service server information, b) device identification information, and c) authentication information.

The representative coupon code may be an N-dimensional code. For example, the representative coupon code may be a bar code or a quick response (QR) code. Furthermore, the representative coupon code may be tag information corresponding to an electric tag. In this case, user equipment 100 may support both of a read mode and a tag emulation mode of near field communication (NFC). For convenience and ease of understanding, the representative coupon code will be described as a QR code, but the present invention is not limited thereto. Further, the present invention is not limited to one particular method for generating a representative coupon code using information on such digital coupons. The coupon representative code may be generated using various methods.

When a consumer makes a payment for a desired purchase, the consumer may control user equipment 100 to display the generated representative coupon code on a display thereof or to transmit the generated representative coupon code to merchant system 200. Based on the representative coupon code, user equipment 100 or merchant terminal 200 automatically select at least one coupon applicable to a desired purchase or a desired merchant. Accordingly, the consumer is able to use at least one associated with a merchant among the coupons digitally stored in user equipment 100 without disruptive or inconvenient processes of searching and determining at least one matched with the merchant among the coupons stored in user equipment 100.

Such a service is provided through a service application downloaded from service server 300, installed in user equipment 100, and executed in user equipment 100 in connection with service server 300. User equipment 100 may be any device used directly by an end-user to communicate and to perform operations associated with the service. User equipment 100 may include a hand-held telephone, a mobile phone, a smart phone, a personal digital assistance (PDA), a pad-like device, a laptop computer equipped with a mobile broadband adapter, and so forth.

Merchant terminal 200 is an electronic device of a merchant, which i) obtains the representative coupon code from user equipment 100, ii) select one applicable to a desired purchase or a desired merchant from a plurality of coupons digitally stored in user equipment 100, and iii) process a payment for the desired purchase with the selected coupon applied. Merchant terminal 200 may be a point-of-sale (POS) terminal of a merchant or a server of a merchant.

Merchant terminal 200 obtains the representative coupon code from user equipment 100 upon a predetermined event. For example, merchant terminal 200 may scan or read the representative coupon code displayed on a display device of user equipment 100. Alternatively, merchant terminal 200 may receive information on the representative coupon code through a communication link established between user equipment 100 and merchant terminal 200. Such a communication link may be a wireless link or a wired link established based on a data communication network, a mobile communication network, or NFC.

From the obtained representative coupon code, merchant terminal 200 detects at least one of a) service server information, b) device identification information, and c) authentication information and generates a coupon request. The coupon request may include at least one of the device ID information and the authentication information with merchant ID information. Then, merchant terminal 200 accesses service server 300 using the service server information and transmits the coupon request to service server 300. In response to the coupon request, merchant terminal 200 may receive information on at least one coupon applicable to an associated merchant from service server 300.

For convenience and ease of understanding, merchant terminal 200 is described herein as receiving information on at least one coupon, but the present invention is not limited thereto. For example, merchant terminal 200 may receive information from service server 300 that indicates no coupon applicable to the associated merchant is available.

Service server 300 may be a server of a service provider that offers the service for helping a consumer to optimally utilize a plurality of coupons stored in user equipment 100 in accordance with at least one embodiment. Service server 300 is coupled to user equipment 100 and merchant system 200 through various types of communication network configurations.

Service server 300 stores and manages coupon information of each user equipment. For example, service server 300 may receive a registration request from user equipment 100 with coupon information thereof. Such coupon information includes at least one of a) information on coupons digitally stored in user equipment, b) information on benefits of each coupon, c) information on user equipment (e.g., device ID information), and d) information for authentication (e.g., authentication information), Service server 300 stores such information in connection with device ID information.

As described, service server 300 is also provided with the authentication information from user equipment 100 with the registration request. Such authentication information is used to authenticate use of a corresponding coupon. Service server 300 stores such authentication information in association with coupon information and/or in association with information on user equipment 100 such as device ID information of user equipment 100.

Service server 300 performs an authentication procedure upon the receipt of a coupon request from user equipment 100. For example, service server 300 may compare authentication information included in the received coupon request with previously stored authentication information associated with the device ID information included in the received coupon request. If the authentication information is matched with the previously stored authentication information, service server 300 determines that a consumer associated with user equipment 100 has a right to use a corresponding coupon (authentication success). Otherwise, service server 300 determines that a consumer associated with user equipment 100 does not have a right to use a corresponding coupon (authentication fail).

In response to the coupon request, service server 300 obtains information on coupons applicable to at least one of a desired merchant and a desired purchase based on merchant ID information or device ID information included in the coupon request. Service server 300 provides such information on applicable coupons to at least one of merchant terminal 200 and user equipment 100.

Service server 300 receives a used coupon confirmation request from merchant terminal 200 and deletes information on used coupons based on information included in the used coupon confirmation request. Furthermore, service server 300 generates a coupon deletion message corresponding to a used coupon and transmits the coupon deletion message to user equipment 100 in order to control user equipment 100 to automatically delete the used coupon after using the coupon.

In addition, service server 300 provides an associated service application to user equipment 100. For example, user equipment 100 downloads the associated service application from service server 300 and installs the downloaded service application for providing such a service to a consumer.

As described, user equipment 100 generates a representative coupon code containing information on all of coupons digitally stored in user equipment 100 with authentication information and service server information and outputs such a generated representative coupon code upon a predetermined event. Hereinafter, such user equipment 100 will be described with reference to FIG. 2.

FIG. 2 illustrates user equipment for provide a service for helping a consumer to optimally utilize coupons stored therein in accordance with at least one embodiment of the present invention.

Referring to FIG. 2, user equipment 100 includes communication circuit 110, memory 120, input/output circuit 130, processor 140, and code generating circuit 150. Although user equipment 200 is illustrated as including four constituent elements, the present invention is not limited thereto. User equipment 100 may further include various elements such as a camera, a sensor, and an interface circuit.

Communication circuit 110 transmits and receives signals to/from other entities (e.g., merchant terminal 200 and service server 300) through a communication network based on various types of communication schemes. For convenience and ease of understanding, user equipment 100 is illustrated as having one communication circuit in FIG. 2, but the present invention is not limited thereto. For example, user equipment 100 may include more than two communication circuits each employing a different communication scheme. Communication circuit 110 may be referred to as a transceiver and include at least one of a mobile communication circuit, a wireless internet circuit, a near field communication (NFC) circuit, a global positioning signal receiving circuit, and so forth. Particularly, communication circuit 110 may include a short distance communication circuit for short distance communication, such as NFC, and a mobile communication circuit for long range communication through a mobile communication network, such as long term evolution (LTE) communication or wireless data communication (e.g., WiFi). Through the short distance communication circuit, user equipment 100 might communicate with merchant terminal 200 (e.g., a POS terminal). Through the mobile communication circuit, user equipment 100 might communicate with service server 300 or other servers through various types of communication networks.

In accordance with at least one embodiment, communication circuit 110 may transmit or receive various types of information to and/or from merchant terminal 200 and service server 300. For example, communication circuit 110 may transmit a registration request to service server 300, transmit a representative coupon code to merchant terminal 200, transmit a payment request to merchant terminal 200, receive coupon information from service server 300, and receive a coupon deletion request from service server 300.

Code generating circuit 150 generates a representative coupon code that represents a plurality of coupons digitally stored in user equipment 100 in response to the control of processor 140. Code generating circuit 150 further includes device ID information, service server information, and authentication information in the representative coupon code. As described, the representative coupon code may be an N-dimensional code, such as a bar code or a QR code.

The device ID information may be information for identifying user equipment 100. The device ID information may be a telephone number assigned to user equipment 100, but the present invention is not limited thereto. The device ID information may be international mobile subscriber identity (IMSI).

The service server information may be information for accessing service server 300 for storing and managing coupon information. For example, the service server information may include a uniform resource locator (URL) or an Internet Protocol (IP) address of service server 300.

The authentication information may be information for authenticating the use of coupons. For example, the authentication information may be used to determine whether an associated consumer has a right to use a corresponding coupon or not. The authentication information may be a token value used for authenticating the use of a corresponding coupon. Such authentication information may be determined, generated, or set at user equipment 110 by at least one of a user, a service provider, and agreement therebetween. For example, the authentication information may be a personal identification number (PIN) or device identification information, but the present invention is not limited thereto. The authentication information may be a hashing result of a corresponding PIN or corresponding device identification information. Furthermore, the authentication information may be predetermined personal information or a hashing result of the predetermined personal information. The present invention is not limited to one particular method for generating a coupon representative code using information on coupons stored in user equipment 100.

Input/output circuit 130 receives various types of inputs from a user (e.g., a consumer) and output a result of processing based on the received inputs. For example, input/output circuit 130 may receive various types of commands for controlling constituent elements of user equipment 100 from a user and display various types of information generated as a result of processing the received inputs in various formats. Particularly, input/output circuit 130 receives touch inputs from a consumer through a predetermined graphic user interface displayed on input/output circuit 130. Furthermore, input/output circuit 130 outputs the result of processing based on the received touch input through the predetermined graphic user interface. In accordance with at least one embodiment, input/output circuit 130 displays a representative coupon code in response to control of processor 140.

Input/output circuit 130 may include a display panel for displaying information, such as a liquid crystal display (LCD), and a touch sensor panel for sensing touch inputs. Such input/output circuit 130 may be referred to as a touch screen. Since such a touch screen and its operation are well known to those skilled in the art, the detailed descriptions thereof are omitted herein. In FIG. 2, user equipment 100 is illustrated as having input/output circuit 130 as one integrated input/output circuit, but the present invention is not limited thereto. User equipment 100 may include various types of input circuits (e.g., keypad, buttons, and sensors) separated from output circuits (a flat panel display).

Memory 120 stores various types of software programs including an operating system for controlling user equipment 100 and at least one application necessary for providing a service to help a consumer to optimally utilize coupons stored in user equipment 100. Furthermore, memory 120 stores various types of data generated during performing operations in user equipment 100.

In accordance with at least one embodiment, memory 120 stores information on a plurality of coupons each issued or downloaded through different application. Such information on a plurality of coupons may be distributed over different memory sectors according to a type of an associated application. Such coupon information includes a name of a coupon, an applicable merchant of a coupon, a coupon benefit (e.g., a discount rate) of a coupon, a valid period of a coupon, an N-dimensional code image of a coupon, and a coupon image of each coupon. Memory 120 also stores authentication information and service server information. Memory 120 stores information on a representative coupon code generated for all of stored coupons.

Processor 140 is central processing circuitry that controls constituent elements of user equipment 100 (e.g., communication circuit 110, memory 120, input/output circuit 130, and code generating circuit 150) based on inputs received through input/output circuit 130 or based on results of performing operations associated with the service.

In accordance with at least one embodiment, processor 140 performs operations for scanning and detecting information on a plurality of coupons, which may be stored in different memory sectors according to a type of an associated application. Processor 140 performs operations for transmitting a registration request with the coupon information to service server 300 through communication circuit 110. The coupon information may further include device ID information and authentication information.

Processor 140 also performs operation for extracting coupon information including an N-dimensional image such as a bar code from each memory 120 and displays the extracted coupon information on input/output circuit 130. Processor 140 may perform an operation for displaying a representative coupon code on input/output circuit 130 or for transmitting the representative coupon code to merchant terminal 200 through communication circuit 110. Processor 140 performs an operation for deleting information associated with a used coupon in response to a coupon deletion request from service server 300.

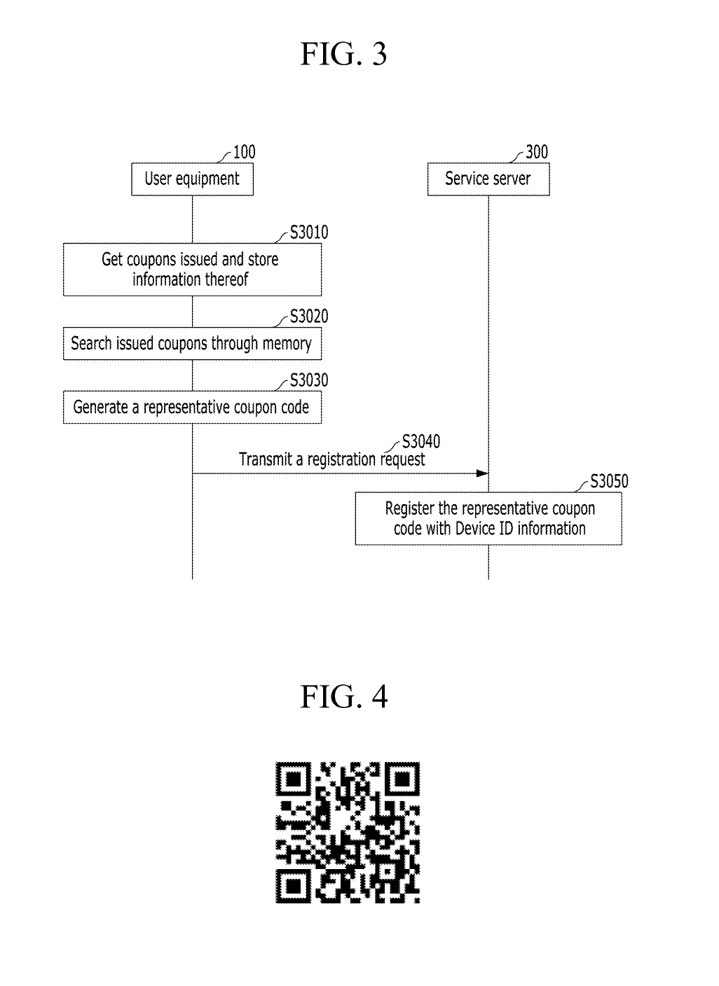

As described, user equipment 100 generates a representative coupon code by detecting information on coupons stored in memory 120 and registers the generated representative coupon code at service server 300 with device ID information thereof. Such operation will be described with reference to FIG. 3.

FIG. 3 illustrates a method for generating a representative coupon code at user equipment and registering the generated representative coupon code at a service server in accordance with at least one embodiment.

Referring to FIG. 3, user equipment 100 stores information on coupons each issued or downloaded through different applications at step S3010. For example, user equipment 100 may apply for predetermined coupons and get the coupons issued from associated servers through various types of applications installed in and executed by user equipment 100. Furthermore, user equipment 100 may download predetermined coupons from associated servers using various types of applications. For example, such application may include a service application, a web-browser application, a message editor application, an instant messenger application, and an e-mail editor application. User equipment 100 stores information on such coupons, as coupon information, in memory 120. Since each coupon may be downloaded or issued through different applications, the information on a plurality of coupons may be distributed over different memory sectors according to a type of an associated application. Such coupon information includes a name of a coupon, an applicable merchant of a coupon, a coupon benefit (e.g., a discount rate) of a coupon, a valid period of a coupon, an N-dimensional code image of a coupon, and a coupon image of a coupon.

At step S3020, user equipment 100 scans memory 120 and collects coupon information distributed over and stored in memory 120 upon a predetermined event. For example, user equipment 100 may scan and collect such coupon information at a regular interval or an event such as the receipt of an initiation input made by a user or an initiation signal from an external device such as merchant terminal 200 or service server 300. Particularly, user equipment 100 searches for images of coupons or N-dimensional codes of coupons through scanning memory sectors of memory 120 and collects coupon information associated with the images or N-dimensional codes.

At step S3030, user equipment 100 generates a representative coupon code for coupons digitally stored in user equipment 100 based on the collected coupon information. For example, user equipment 100 may generate a representative coupon code to contain coupon information of all coupons digitally stored in memory 120. That is, the representative coupon code includes a name of each coupon, an applicable merchant of each coupon, a coupon benefit (e.g., a discount rate) of each coupon, a valid period of each coupon, an N-dimensional code image of each coupon, and a coupon image of each coupon. In addition to coupon information, the representative coupon code includes device ID information, service server information, and authentication information. The device ID information may be information on a telephone number or IMSI of user equipment 100 for identifying user equipment 100. The service server information may be information on service server 300 such as, a URL address or an IP address of service server 300. The authentication information may be information for authenticating the use of coupons, such as a PIN, device identification information, or personal information. Such authentication information may be generated or set by a user, a service provider, or agreement therebetween.

User equipment 100 may generate a representative coupon code upon a predetermined event, for example, whenever a new coupon is issued or downloaded at user equipment 100. The present invention, however, is not limited thereto. User equipment 100 may regenerate a representative coupon code when device ID information is changed or when service server information is changed. Furthermore, user equipment 100 may regenerate the representative coupon code at a predetermined regular interval.

FIG. 4 illustrates a representative coupon code in accordance with at least on embodiment. As shown, the representative coupon code is illustrated as a QR code, but the present invention is not limited thereto. As described, the representative coupon code may be any other N-dimensional code, such as a bar code. As described, the present invention is not limited to a particular method for generating a representative coupon code, such as an N-dimensional code. Accordingly, the detailed description thereof will be omitted herein.

Referring back to FIG. 3, at step S3040, user equipment 100 generates a coupon registration request and transmits the generated coupon registration request to service server 300. User equipment 100 may transmit the collected coupon information, the device ID information, the generated representative coupon code information, and the authentication information with the generated coupon registration request to service server 300.

At step S3050, service server 300 receives the coupon registration request from user equipment 100 with at least one of the collected coupon information, the device ID information, the authentication information, and the representative coupon code information and performs a registration procedure in response to the coupon registration request. For example, in response to the coupon registration request, service server 300 registers the representative coupon code in connection with information on user equipment 100. That is, service server 300 may store the collected coupon information, the authentication information, and the representative coupon code information in association with the device ID information and manages the stored information.

Such a registration procedure is repeatedly performed upon a predetermined event. For example, when a new coupon is issued or downloaded at user equipment 100, when device ID information of user equipment 100 is changed, or when authentication information of user equipment 100 is changed, user equipment 100 regenerates a representative coupon code and registers the regenerated representative coupon code at service server 300 again for updating the registration. For the initial registration, user equipment 100 may transmit coupon information of all coupons digitally stored in user equipment 100 to service server 300 for registration. After the initial registration, user equipment 100 may only transmit coupon information of a new coupon to service server 300 for registration.

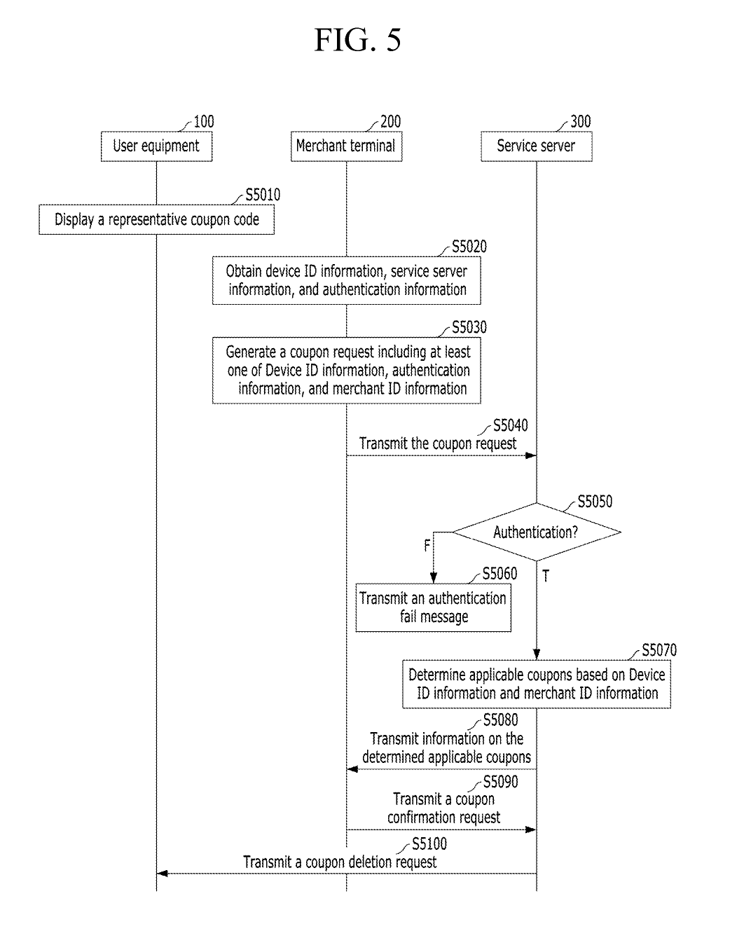

After the registration, user equipment 100 outputs a representative coupon code to merchant system 200 in order to optimally utilize coupons digitally stored in user equipment 100 in connection with service server 300 in accordance with at least one embodiment. Such operation will be described in detail with reference to FIG. 5.

FIG. 5 illustrates a method for providing a service for helping a consumer to optimally utilize coupons stored in user equipment in accordance with at least one embodiment.

Referring to FIG. 5, user equipment 100 outputs a representative coupon code upon a predetermined event at step S5010. For example, user equipment 100 may display the representative coupon code on a display device (e.g., input/output circuit 130) of user equipment 100 upon a predetermined event. Alternatively, user equipment 100 may transmit information on the representative coupon code to merchant terminal 200 upon a predetermined event. The predetermined event may include the receipt of a user input for displaying the representative coupon code, the receipt of a user input for initiating an associated service application, the receipt of a user input for initiating a payment process, the receipt of a predetermined signal transmitted from other device such as merchant terminal 200 or service server 300, and so forth. That is, when a consumer wants to make a payment with one of coupons, the consumer may control user equipment 100 to display the representative coupon code on a display device of user equipment 100 to merchant terminal 200 or to transmit information on the representative coupon code to merchant terminal 200.

At step S5020, merchant terminal 200 obtains device ID information, service server information, and authentication information from the representative coupon code. For example, merchant terminal 200 may scan the representative coupon code displayed on user equipment 100 or receive information on the representative coupon code from user equipment 100. Merchant terminal 200 may decode the representative coupon code and obtain information contained in the representative coupon code. The obtained information may include device ID information, service server information, and authentication information as well as coupon information of coupons stored in corresponding user equipment 100.

At step S5030, merchant terminal 200 generates a coupon request including the device ID information and the authentication information with merchant identification (ID) information. The merchant ID information may be information for identifying a merchant. For example, the merchant ID information may be a merchant code. If multiple merchant terminals are present in one merchant location (e.g., a shop), the merchant ID information may further include identification information on each merchant terminal.

At step S5040, merchant terminal 200 transmits the generated coupon request to service server 300 using the service server information. As described, the service server information is a URL address or an IP address. Based on the URL address or the IP address included in the service server information, merchant terminal 200 transmit the generated coupon request to service server 300.

At step S5050, service server 300 receives the coupon request from merchant terminal 200 and performs an authentication procedure based on the information included in the coupon request. For example, upon the receipt of the coupon request, service server 300 may extract device ID information and authentication information from the received coupon request and compare the extracted authentication information with previously stored authentication information corresponding to the device ID information. Such previously stored authentication information may be stored during the registration procedure.

When authentication fails (S5050-F), service server 300 transmits an authentication failure message to merchant terminal 200 or user equipment 100 at step S5060. For example, when the extracted authentication information is not matched with the previously stored authentication information, service server 300 determines that authentication is failed and transmits the authentication failure message to at least one of merchant terminal 200 and user equipment 100.

Otherwise (S5050-T), service server 300 obtains information on coupons applicable to a desired merchant at step S5070. For example, service server 300 reads information on coupons applicable to the desired merchant, which information is stored in connection with at least one of the device ID information and the merchant ID information.

At step S5080, service server 300 transmits the obtained information on applicable coupons to merchant terminal 200. For example, service server 300 may transmit the applicable coupon information to at least one of merchant terminal 200 and user equipment 100. In case of transmitting to user equipment 100, user equipment 100 may transmit the received applicable coupon to merchant 200. The applicable coupon information may include information on a name of each applicable coupon, a benefit associated with each applicable coupon, a valid period of each applicable coupon, and so forth.

At step S5090, merchant 200 performs a payment process by applying at least one of applicable coupons based on the applicable coupon information and transmits a sued coupon confirmation request to service server 300 after using at least one of the applicable coupons. For example, merchant terminal 200 may apply a benefit associated with an applicable coupon to the payment process. When the benefit of the applicable coupon is a discount rate, merchant terminal 200 calculates an estimated payment amount of a desired purchase by applying the discount rate on the price. If there are multiple applicable coupons associated with the desired merchant, merchant terminal 200 may apply all of applicable coupons to the payment process. Furthermore, merchant terminal 200 may automatically select at least one of the multiple applicable coupons according to a consumer preference or a predetermined priority, which might be determined or set by a consumer, a service provider, or agreement therebetween. In addition, merchant terminal 200 may receive an input signal from user equipment 100 to select one of the multiple applicable coupons.

For example, merchant terminal 200 generates a used coupon confirmation request with information on the used applicable coupon after preforming the payment process. That is, the used coupon confirmation request may include identification information of the used applicable coupon.

At step S5100, service server 300 receives the used coupon confirmation request from merchant terminal 200, deletes coupon information associated with the information on the used coupon, generates a coupon deletion request with information on the deleted coupon, and transmits the generated coupon deletion request to user equipment 100. The coupon deletion request may include identification information on the deleted coupon which is the used coupon. In response to the coupon deletion request, user equipment 100 deletes corresponding coupon from memory 120 thereof.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present invention can be embodied in the form of methods and apparatuses for practicing those methods. The present invention can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

No claim element herein is to be construed under the provisions of 35 U.S.C. §112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of user equipment for utilizing coupons stored in the user equipment, the method comprising:
collecting information on coupons stored in the user equipment by scanning memory sectors of the user equipment;
generating a representative coupon code that represents the coupons stored in the user equipment by including the obtained coupon information with device identification (ID) information, authentication information, and service server information; and
outputting the generated representative coupon code upon a predetermined event.

2. The method of claim 1, wherein the obtaining information includes:
downloading coupons from associated servers through different applications installed and executed in the user equipment; and
storing the downloaded coupons in memory sectors assigned to corresponding applications.

3. The method of claim 1, wherein the generating a representative coupon code includes:
generating at least one of a bar code and a quick response (QR) code as the representative coupon code.

4. The method of claim 1, wherein:
the coupon information includes information on at least one of a name of each coupon, an applicable merchant of each coupon, a coupon benefit of each coupon, a valid period of each coupon, an N-dimensional code image of each coupon, and a coupon image of each coupon;
the device ID information includes information on at least one of a telephone number or an international mobile subscriber identity (IMSI) of the user equipment;
the service server information includes at least one of a uniform resource locator (URL) address and an internet protocol (IP) address of an associated service server; and
the authentication information includes at least one of a personal identification number (PIN), device identification (ID) information, predetermined personal information, and a hashing result of at least one of the PIN, the device ID information, and the predetermined personal information.

5. The method of claim 1, wherein the outputting the generated representative coupon code includes:
transmitting the generated representative coupon code to a merchant terminal through a communication link established between the user equipment and the merchant terminal.

6. The method of claim 1, wherein the outputting the generated representative coupon code includes:
displaying the generated representative coupon code on a display device of the user equipment.

7. The method of claim 1, wherein the predetermined event includes at least one of:
receiving a user input for display of the representative coupon code;
receiving a user input to initiate an associated service application;
receiving a user input to initiate a payment process; and
receiving a predetermined signal transmitted from one of a merchant terminal and an associated service server.

8. The method of claim 1, comprising:
transmitting a registration request with the generated representative coupon code, the authentication information, and the device ID information to a service server.

9. The method of claim 1, comprising:
receiving a coupon deletion request from the service server; and
deleting coupon information associated with the coupon deletion request.

10. A method of a merchant terminal for utilizing coupons stored in user equipment, the method comprising:
obtaining information on a representative coupon code from the user equipment;
obtaining information on applicable coupons to at least one of a related merchant and a desired purchase based on the obtained representative coupon code from an associated service server; and
performing a payment procedure applying at least one of the applicable coupons based on the obtained information.

11. The method of claim 10, wherein the obtaining information on a representative coupon code includes:
receiving information on the representative coupon code from the user equipment through a communication link established between the user equipment and the merchant terminal.

12. The method of claim 10, wherein the obtaining information on a representative coupon code includes:
scanning the representative coupon code displayed on a display device of the user equipment.

13. The method of claim 10, wherein the obtaining information on applicable coupons includes:
extracting authentication information, service server information, and device ID information from the obtained representative coupon code by decoding the obtained representative coupon code;
transmitting a coupon request with the extracted authentication information, the extracted device ID information, and merchant identification (ID) information to the associated service server based on the extracted service server information; and
receiving the information on applicable coupons associated with at least one of a related merchant and a desired purchase from the associated service server.

14. The method of claim 10, comprising:
transmitting a used coupon confirmation request to the associated service server after the performing a payment procedure.

15. A method of a service server for utilizing coupons stored in user equipment, the method comprising:
receiving a coupon request from a merchant terminal;
obtaining information on coupons applicable to a related merchant or a desired purchase based on the received coupon request; and
providing the obtained information to at least one of the merchant terminal and the user equipment.

16. The method of claim 15, wherein the obtaining information includes:
extracting device identification (ID) information and merchant identification (ID) information from the received coupon request; and
obtaining the information on applicable coupons based on at least one of the device ID information and the merchant ID information.

17. The method of claim 15, comprising:
extracting authentication information from the received coupon request; and
performing an authentication procedure of the coupon request based on the extracted authentication information.

18. The method of claim 15, comprising:
receiving a registration request with a representative coupon code, coupon information, authentication information, and device identification (ID) information from the user equipment; and
storing the representative coupon code, the coupon information, and the authentication information in connection with the device ID information of the user equipment.

19. The method of claim 15, comprising:
receiving a used coupon confirmation request from the merchant terminal; and
deleting information on coupons indicated as a used coupon based on the received used coupon confirmation request.

20. The method of claim 19, comprising;
transmitting a coupon deletion request to user equipment for deleting the detected coupons.
